(19) United States
(12) Patent Application Publication
(10) Pub. No.: US 2006/0262101 A1
(43) Pub. Date: Nov. 23, 2006

(54) Expanded electrode grid of a capacitance sensitive touchpad by using demultiplexing of signals to the grid as controlled by binary patterns from a touch sensor circuit

(76) Inventors: Michael D. Layton, Salt Lake City, UT (US); Daniel J. Lee, Salt Lake City, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/351,889

(22) Filed: Feb. 10, 2006

Related U.S. Application Data
(60) Provisional application No. 60/651,890, filed on Feb. 10, 2005.

(51) Int. Cl. G09G 5/00

(52) U.S. Cl. 345/173

(57) ABSTRACT

A demultiplexer disposed between a touch sensor circuit and electrodes of a touchpad electrode grid, wherein instead of using the touch sensor circuitry to directly drive each electrode, the touch sensor circuitry instead transmits control signals to the demultiplexer, wherein the control signals instruct the demultiplexer to select a subset of the plurality of electrodes to be driven, and thereby perform object detection and tracking, wherein by using the demultiplexer to drive electrodes, a much greater number of electrodes can be driven by the touch sensor circuit, thereby increasing the effective size of a touchpad that can be controlled by the touch sensor circuitry.

### CROSS REFERENCE TO RELATED APPLICATIONS

This document claims priority to and incorporates by reference all of the subject matter included in the provisional patent application docket number 3247.CIRQ.PR, having Ser. No. 60/651,890 and filed on Feb. 10, 2006.

### FIELD OF THE INVENTION

This invention relates generally to capacitance sensitive touchpads. More specifically, the number of electrodes of a capacitance sensitive touchpad is significantly increased by sending signals through a demultiplexer, wherein the choice of which electrodes are activated by the demultiplexer are determined by signals sent by touch sensor circuitry to the demultiplexer, instead of sending the signals from the touch sensor circuit directly to the touchpad electrodes.

### DESCRIPTION OF RELATED ART

The state of the art in capacitance sensitive touchpads is characterized by the touchpad and touchpad sensor circuitry of Cirque® Corporation. Cirque® Corporation touchpad technology has evolved from its first implementation, but several features of the past and present hardware and testing methodology can be used to demonstrate the present invention.

From a hardware perspective as shown in FIG. 1, a capacitance sensitive touchpad 10 as taught by Cirque® Corporation includes a grid of row 12 and column 14 (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. A touchpad sensor circuit 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touch sensor circuitry 20.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touch sensor circuitry 20 is in a balanced state, and there is no signal on the sense line 16. There may or may not be a capacitive charge on the electrodes 12, 14. In the methodology of Cirque® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P,N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touch sensor circuit 20 is directly driving the electrodes 12, 14 of the touchpad 10. Thus, for a typical 12×16 electrode grid touchpad, there are a total of 28 pins (12+16=28) available from the touch sensor circuitry 20 that are used to drive the electrodes 12, 14 of the electrode grid.

It would be an advantage over the state of the art to use existing touch sensor circuitry 20 that is capable of driving a typical electrode grid and instead drive a much larger number of electrodes than the number of available pins, and thereby increase the overall size, resolution and/or linearity of the capacitance sensitive touchpad 10 that can be controlled by standard touchpad circuitry 20.

### BRIEF SUMMARY OF THE INVENTION

It is an object of the present invention to provide a demultiplexer between touch sensor circuitry and the electrodes of a capacitance sensitive touchpad.

It is another object to use control signals from the touch sensor circuitry to thereby control the grouping of signals that are transmitted to the touchpad electrodes.

It is another object to increase the total number of electrodes that are controllable by given touch sensor circuitry by not using the touch sensor circuit to directly drive touchpad electrodes.

In a first embodiment, the present invention is a demultiplexer disposed between a touch sensor circuit and electrodes of a touchpad electrode grid, wherein instead of using the touch sensor circuitry to directly drive each electrode, the touch sensor circuitry instead transmits control signals to the demultiplexer, wherein the control signals instruct the demultiplexer to select a subset of the plurality of electrodes to be driven, and thereby perform object detection and tracking, wherein by using the demultiplexer to drive electrodes, a much greater number of electrodes can be driven by the touch sensor circuit, thereby increasing the effective size of a touchpad that can be controlled by the touch sensor circuitry.

In a first aspect of the present invention, a single large touchpad can be operated using touch sensor circuitry that has much less drive pins than the total number of electrodes of the single large touchpad.

In a second aspect of the present invention, a plurality of different touchpads can be operated using a single touch sensor circuit.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a schematic block diagram of a prior art touch sensor circuit and an electrode grid of a capacitance sensitive touchpad.

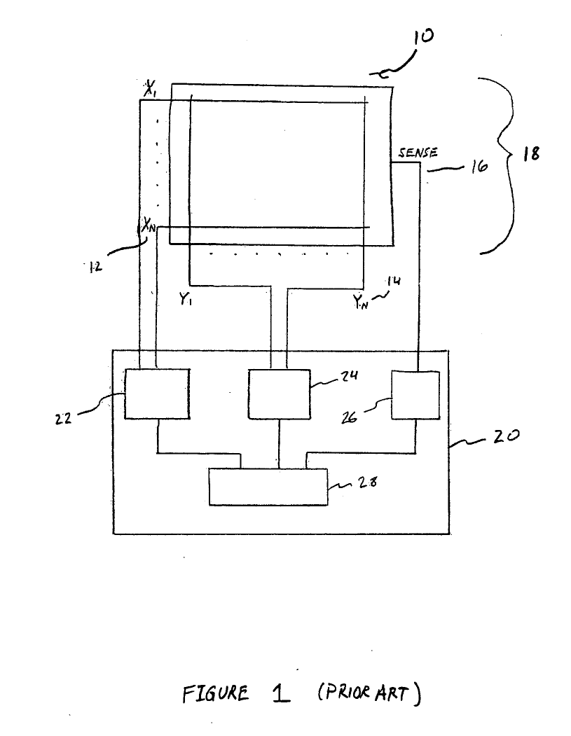

FIG. 2 is a schematic block diagram that illustrates the elements of a preferred embodiment of the present invention that incorporates a demultiplexer to thereby effectively control an electrode grid that has a greater number of electrodes than the number of drive pins on the touchpad sensor circuitry.

FIG. 3 is a schematic diagram that illustrates how the principles of the present invention can be applied to using a single touch sensor circuit to drive a plurality of touchpads.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

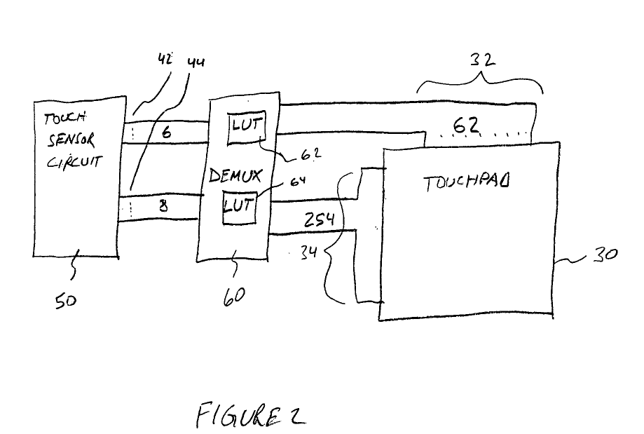

In a first embodiment of the present invention, a modified capacitance sensitive touchpad 30 is shown in FIG. 2 that is capable of performing object detection and tracking on a surface thereof. Such a touchpad 30 is manufactured by Cirque® Corporation. The purpose of the first embodiment of the present invention is to make it possible to utilize a touchpad having a greater number of electrodes 32, 34 than the number of drive pins 42, 44 on the touchpad sensor circuitry 50, without having to modify the touchpad sensor circuitry that transmits control signals to the electrodes 32, 34 of the touchpad 30. Accordingly, the first embodiment overcomes the prior art limitation of having a one-to-one relationship between the drive pins 42, 44 on the touch sensor circuitry 50, and the number of electrodes 32, 34 in the touchpad 30. Another way of looking at the invention is to realize that an existing touchpad sensor circuit 50 can be used to drive a touchpad with many more electrodes than before because they are not being directly driven.

The first embodiment uses indirection to increase the total number of touchpad electrodes 32, 34 that can be driven by a given set of drive pins 42, 44 of touchpad sensor circuitry 50. Instead of directly driving electrodes 32, 34, the touchpad sensor circuitry 50 sends control signals to a demultiplexer 60 as shown in FIG. 2.

In one embodiment, the control signals take the form of a coded index using binary numbers that define a pattern of electrodes 32, 34 to be driven by the demultiplexer 60. For example, if the touchpad sensor circuitry 50 has four drive pins, it would normally only be able to drive four electrodes. By generating binary numbers, the touchpad sensor circuit can generate a total of 24 or 16 unique binary numbers, and thus drive a much larger touchpad electrode grid.

The control signals of the present invention can do more than just provide an index into which electrodes are to be driven by the demultiplexer. For example, the control signals can be used to provide at least one signal that controls transition timing which is used in driving the touchpad electrode grid.

Another use of the control signals is to use them to enable the touchpad sensor circuitry to send a signal as to which axis of the touchpad electrode grid is to be driven. Thus, there may be a reason to drive the X axis of electrodes before the Y axis of electrodes, and vice versa.

Another use of control signals may be to implement a wide/narrow scanning pattern. Detection of a pointing object on the touchpad surface is going to require broad scans across all electrodes of the touchpad, but not scans in great detail. Accordingly, a wide scan is implemented at first in order to simply detect a pointing object. Once the object is detected, the scanning method changes to a narrow scanning method in order to more precisely track movement of the pointing object on the touchpad surface. Accordingly, control signals may be used to implement wide scanning and narrow scanning modes of operation of the touchpad.

A final use of control signals is the ability to shut down operation of the demultiplexer. This operation is desired in order to prevent unnecessary drive transitions.

Cirque® Corporation presently manufactures two different touch sensor circuits for driving electrodes on a touchpad electrode grid. The two touchpad sensor circuits have 14 (6+8=14) and 28 (12+16=28) drive pins. Accordingly, the 14 pin touchpad sensor circuitry 50 can drive (2⁶−2) or 62 “X” electrodes 32, and (2⁸−2) or 254 “Y” electrodes 34 using the 6×8 touchpad sensor circuitry 50. The number of X and Y electrodes 32, 34 can be switched, as this selection was arbitrary. Likewise, the 12×16 touchpad sensor circuitry can drive (2¹²−2) or 4094 X electrodes, and (2¹⁶−2) or 1,048,574 Y electrodes.

Further along this line of development, it should be apparent that the touchpad electrode grid 30 that can be driven using the demultiplexing of the present invention is not limited to the same grid patterns. In other words, the 6×8 touch sensor circuitry 50 that has 14 pins 42, 44 for driving electrodes 32, 34 can be divided up so as to be able to drive many different grid patterns. For example, the 14 pins can be divided up so that 3 pins are for X electrodes, and the remaining 11 pins are for the Y electrodes. This would result in a touchpad electrode grid having (2³−2) or 6 X electrodes 32, and (2¹¹−2) or 2046 Y electrodes 34. Thus, even though the touch sensor circuitry 50 was originally designed to drive specific electrode grid patterns because of direct one-to-one pin assignments, the pins 42, 44 can now be reassigned for any desired electrode grid pattern.

FIG. 2 is a block diagram of an embodiment of the present invention based on the principles described above. The touchpad is comprised of the touch sensor circuitry 50, a demultiplexer 60, and a single touchpad electrode grid 30. The touch sensor circuitry 50 sends control signals to the demultiplexer 60 via the output pins 42, 44 to thereby select which electrodes 32, 34 of the touchpad electrode grid 30 are being driven to thereby perform object detection and tracking on the surface of the touchpad.

The demultiplexer 60 receives the control signals and utilizes two lookup tables, on lookup table 62 for the X electrodes and one lookup table 64 for the Y electrodes, to thereby decode the control signals and determine which electrodes 32, 34 are to be driven on the touchpad electrode grid 30. The number of electrodes 32, 34 that can be driven by the touch sensor circuitry 50 is now much greater than if the electrode grid 30 was being driven directly by the drive pins 42, 44.

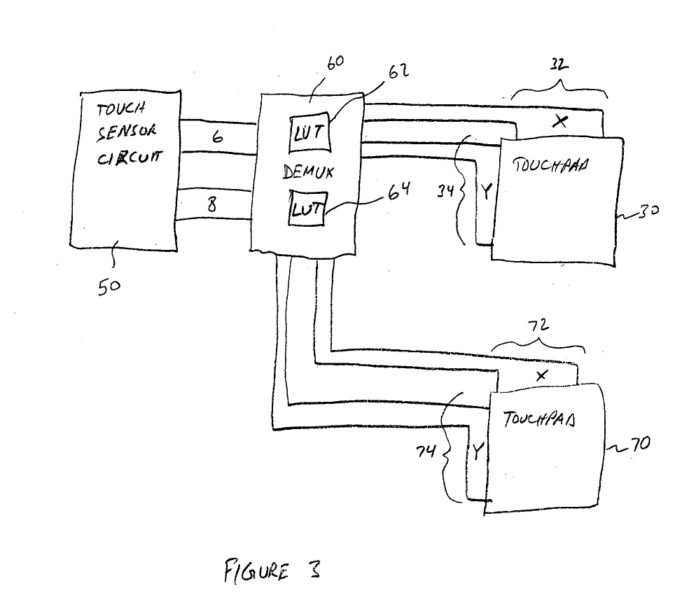

In light of the increase in the number of electrodes that can be driven, the present invention makes possible another significant improvement over the state of the art. Specifically, FIG. 3 is provided as a block diagram of another embodiment of the present invention. The same touch sensor circuitry 50 of FIG. 2 can also be used to drive a plurality of touchpads 30, 70 instead of single large touchpad. Thus, a single demultiplexer 60 is now coupled to a plurality of touchpad electrode grids 30, 70. In FIG. 3, only two touchpads 30, 70 are shown for illustration purposes only. It should be recognized that many more touchpads can be driven from the same demultiplexer 60.

By way of illustration, it is observed that other electronic circuitry can be used to replace the demultiplexer 60 of the present invention. Any equivalent circuitry can be used that is capable of receiving a control signal and then driving a selected set of electrodes of a touchpad electrode grid. What is important is that the function of the demultiplexer 60 be replicated in the equivalent circuitry.

The control signals of the present invention should also be considered. Operation of a demultiplexer is well understood by those skilled in the art. Simple binary commands can be used to control the output. Similarly, the control signals that would be sent to equivalent circuitry may be identical binary coded control signals, or may be some equivalent. Thus, it is not important what form the controls signals should take, only that the control signals should be capable of being correctly formatted for the particular equivalent circuitry being used to replace the demultiplexer.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A capacitance sensitive touchpad system for performing object detection and tracking on a surface of a first touchpad, said touchpad system comprised of:
a touch sensor circuit;
a plurality of electrodes arranged in rows and columns of a first touchpad electrode grid; and
a demultiplexer coupled to the touch sensor circuit for receiving control signals therefrom, and coupled to the plurality of electrodes to thereby transmit drive signals thereto according to the control signals.

2. The capacitance sensitive touchpad system as defined in claim 1 wherein the touchpad system is further comprised of at least one lookup table, wherein the at least one lookup table enables the demultiplexer to determine which of the plurality of electrodes are to be driven by decoding the control signals received from the touch sensor circuit.

3. The capacitance sensitive touchpad as defined in claim 2 wherein the touchpad system is further comprised of two lookup tables, wherein a first lookup table is used to determine which row electrodes of the plurality of electrodes are to be driven, and wherein a second lookup table is used to determine which column electrodes of the plurality of electrodes are to be driven.

4. The capacitance sensitive touchpad system as defined in claim 1 wherein the touchpad system is further comprised of a second touchpad.

5. The capacitance sensitive touchpad as defined in claim 4 wherein the second touchpad is further comprised of a plurality of electrodes arranged in rows and columns of a second touchpad electrode grid.

6. The capacitance sensitive touchpad as defined in claim 5 wherein the demultiplexer is coupled to the first and the second touchpad electrode grid, wherein the touch sensor circuit controls operation of the first and the second touchpad.

7. The capacitance sensitive touchpad as defined in claim 1 wherein the demultiplexer is replaced with equivalent circuitry, wherein the equivalent circuitry provides the function of receiving control signals from the touch sensor circuit, determining which electrodes of the plurality of electrodes are to be driven, and driving the appropriate electrodes of the plurality of electrodes.

8. The capacitance sensitive touchpad as defined in claim 1 wherein the control signals are further comprised of a coded index that indicate which electrodes of the plurality of electrodes are to be driven by the demultiplexer.

9. A capacitance sensitive touchpad for performing object detection and tracking on a surface thereof, said touchpad system comprised of:
a touch sensor circuit having a set number of drive pins;
a plurality of electrodes arranged in rows and columns of a touchpad electrode grid, wherein the plurality of electrodes are greater in number than the set number of drive pins; and
a demultiplexer coupled to the touch sensor circuit for receiving control signals from the set number of drive pins, and coupled to the plurality of electrodes, wherein the demultiplexer transmits drive signals to the plurality of electrodes according to the control signals received through the set number of drive pins.

10. A method for driving a plurality of electrodes on a capacitance sensitive touchpad from a touch sensor circuit having a fewer number of drive pins than the number of the plurality of electrodes, said method comprising the steps of:
(1) providing a touch sensor circuit, a plurality of electrodes arranged as a touchpad electrode grid, and a demultiplexer disposed between the touch sensor circuit and the plurality of electrodes;
(2) generating a control signal that is transmitted from the touch sensor circuit to the demultiplexer, wherein the control signal is an index as to which electrodes of the plurality of electrodes are to be driven; and
(3) generating drive signals from the demultiplexer to the plurality of electrodes as determined by the control signal, wherein the total number of electrodes of the plurality of electrodes is greater than the total number of drive pins of the touch sensor circuit.

11. A method for performing object detection and tracking on a surface of a touchpad using indirect driving of electrodes, said method comprising the steps of:
(1) providing touch sensor circuitry, a first plurality of electrodes arranged in rows and columns of a first touchpad electrode grid, and a demultiplexer coupled to the touch sensor circuit for receiving control signals therefrom, and coupled to the first plurality of electrodes to thereby transmit drive signals thereto according to the control signals; and
(2) sending a series of control signals from the touch sensor circuitry to the demultiplexer as an index as to which electrodes are to be driven of the first touchpad electrode grid;
(3) driving select electrodes of the first touchpad electrode grid using drive lines from the demultiplexer instead of the touch sensor circuitry; and
(4) determining the location and performing tracking of the object on the surface of the first touchpad.

12. The method as defined in claim 11 wherein the method further comprises the steps of:
(1) providing a lookup table to translate the series of control signals into specified electrodes of the first touchpad electrode grid; and
(2) translating the series of control signals to determine which electrodes of the first touchpad electrode grid are to be driven.

13. The method as defined in claim 11 wherein the method further comprises the steps of:
(1) providing two lookup tables, wherein a first lookup table is used to determine which row electrodes of the first plurality of electrodes are to be driven, and wherein a second lookup table is used to determine which column electrodes of the first plurality of electrodes are to be driven; and
(2) translating the series of control signals to determine which electrodes of the first touchpad electrode grid are to be driven.

14. The method as defined in claim 11 wherein the method further comprises the step of providing a second plurality of electrodes arranged in rows and columns of a second touchpad electrode grid, wherein the second touchpad electrode grid is coupled to the demultiplexer to receive control signals therefrom.

15. The method as defined in claim 14 wherein the method further comprises the step of replacing the demultiplexer with equivalent circuitry, wherein the equivalent circuitry provides the function of receiving control signals from the touch sensor circuit, determining which electrodes of the first plurality of electrodes are to be driven, and driving the appropriate electrodes of the first plurality of electrodes.

16. The method as defined in claim 11 wherein the method further comprises the step of using the control signals as a coded index that indicates which electrodes of the first plurality of electrodes are to be driven by the demultiplexer.

17. The method as defined in claim 11 wherein the method further comprises the step of using the control signals to provide at least one signal that controls transition timing which is used in driving the first touchpad electrode grid.

18. The method as defined in claim 11 wherein the method further comprises the step of using the control signals to send a signal as to which axis of the touchpad electrode grid is to be driven.

19. The method as defined in claim 11 wherein the method further comprises the step of using the control signals to implement wide scanning and narrow scanning modes of operation of the touchpad.

20. The method as defined in claim 11 wherein the method further comprises the step of using the control signals to deactivate the demultiplexer to thereby prevent unnecessary drive transitions.

21. A method for performing object detection and tracking on a plurality of touchpads using indirect driving of electrodes, said method comprising the steps of:
(1) providing touch sensor circuitry, a first plurality of electrodes arranged in rows and columns of a first touchpad, a second plurality of electrodes arranged in rows and columns of a second touchpad, and a demultiplexer coupled to the touch sensor circuit for receiving control signals therefrom, and coupled to the first plurality of electrodes and the second plurality of electrodes to thereby transmit drive signals thereto according to the control signals; and
(2) sending a series of control signals from the touch sensor circuitry to the demultiplexer as an index as to which electrodes are to be driven of the first touchpad and the second touchpad;
(3) driving select electrodes of the first touchpad and the second touchpad using drive lines from the demultiplexer instead of the touch sensor circuitry; and
(4) determining the location and performing tracking of the object on the surface of the first touchpad and the second touchpad.
